(19) United States
(12) Patent Application Publication
(10) Pub. No.: US 2025/0200369 A1
(43) Pub. Date: Jun. 19, 2025

(54) INFORMATION PROCESSING SYSTEM AND NEURAL NETWORK CONVERSION METHOD

(71) Applicant: Hitachi, Ltd., Chiyoda-ku, Tokyo (JP)

(72) Inventors: Masahiko ANDO, Tokyo (JP); Takashi OSHIMA, Tokyo (JP); Norikatsu TAKAURA, Tokyo (JP)

(21) Appl. No.: 18/690,518

(22) PCT Filed: Nov. 18, 2022
(86) PCT No.: PCT/JP2022/042792

§ 371 Date: Nov. 5, 2024

(30) Foreign Application Priority Data
Mar. 29, 2022 (JP) 2022-054452

(51) Int. Cl. G06N 3/082

(52) U.S. Cl. CPC G06N 3/082

(57) ABSTRACT

The present invention reduces the inference time on a GPU for a DNN algorithm for which the weight has been reduced by using an unstructured pruning method. This information processing system comprises: an unstructured pruning unit; a processing unit; a sharing unit; an inference high speed unit; and a control unit. The unstructured pruning unit performs unstructured pruning of a DNN model. The processing unit prunes and compresses, as selected layers, one portion of each layer of the trained DNN model, and does not prune and compress another portion, which serves as an unselected layer. The sharing unit shares the pruned and compressed selected layers. The control unit re-integrates the shared selected layers and the unselected layers to generate a re-integrated layer. The inference high speed unit generates an execution file by optimizing the re-integrated layer to suit prescribed inference hardware.

### TECHNICAL FIELD

The present invention relates to an inference system using deep learning.

### BACKGROUND ART

Recently, a deep learning inference algorithm using a deep neural network (DNN), and a hardware implementation system thereof have been widely used due to high identification performance thereof.

On the other hand, the number of network parameters (a weight coefficient, a bias, and the like) extremely increases in order to obtain high identification performance. Accordingly, the amount of memory in use and a calculation cost, which are required, increase, and in order to execute real-time inference processing, a graphics processing unit (GPU: an image processing device) hardware device, which is expensive and has high power consumption, is required, and thus, the processing is not completed by the built-in microcomputer. In particular, such a tendency is strong in convolutional neural network (CNN) processing with a large amount of image-based information.

As a method in which high speed inference processing can be performed on a built-in type GPU, which is comparatively inexpensive and has low power consumption, the following methods are known. The first method is a method for reducing the weight of a DNN algorithm. The second method is a method for studying a compiler performing conversion (compilation) to a machine language or a code of which the level is lower than that of the original algorithm such that a DNN algorithm is operated on specific GPU hardware at a high speed.

Examples of the first method for reducing the weight of the DNN algorithm include a pruning method for reducing a computation amount or a memory capacity, which is required for processing, by removing connections between the units of the DNN that are determined not to affect an accuracy (Non-Patent Document 1).

Such a pruning method is broadly divided into two types in accordance with a pruning network structure. The first type is a “structured pruning method” for regularly and collectively pruning the weight in structural unit such as a layer or a filter. The second type is an “unstructured pruning method” for performing random pruning in weight unit, which is the minimum unit, (Non-Patent Document 2).

In the case of using the existing GPU, it is known that there is a trade-off relationship between an inference time and an identification accuracy, in the two types of pruning methods described above. In the case of using the structured pruning method, the inference time is reduced, but the identification accuracy decreases compared to the unstructured pruning method. In the case of using the unstructured pruning method, the identification accuracy does not decrease, but the inference time is not reduced compared to the structured pruning method.

As the compiler, which is the second method, a GPU compiler (hereinafter, referred to as an unstructured pruning compiler) for allowing a trained DNN that is pruned by an unstructured pruning method to perform a high speed inference operation on a GPU has been recently proposed (Non-Patent Document 3).

In addition, there is also a method for reducing an inference time by combining processing over a plurality of layers into one layer and optimizing a method for using a memory with a general DNN as a target, regardless of the pruning. As a specific example of this method, a GPU compiler (hereinafter, referred to as an inference high speed compiler) for optimizing a trained model for specific GPU hardware is provided from a GPU manufacturer or the like. For example, TensorRT (Trademark) that is manufactured by NVIDIA Corporation is a software development kit (SDK) for executing deep learning inference at a high speed, which is provided for a GPU manufactured by NVIDIA Corporation.

### CITATION LIST

### Non-Patent Document

Non-Patent Document 1: T. Hoefler, et al., Sparsity in Deep Learning: Pruning and growth for efficient inference and training in neural networks, arXiv:2102.00554v1 [cs.LG] 31 Jan. 2021.
Non-Patent Document 2: H. Tanaka, D. Kunin, D. L. K. Yamins, and S. Ganguli, Pruning neural networks without any data by iteratively conserving synaptic flow, arXiv:2006.05467v3 [cs.LG] 19 Nov. 2020.
Non-Patent Document 3: Z. Wang, SparseRT: Accelerating Unstructured Sparsity on GPUs for Deep Learning Inference, arXiv: 2008.11849v1 [cs.LG] 26 Aug. 2020.

### SUMMARY OF THE INVENTION

### Problems to be Solved by the Invention

The unstructured pruning compiler of Non-Patent Document 3 is effective only in computation between single layers configuring the network (sparse matrix multiplication), and even in a case where the unstructured pruning compiler is applied to computation between a plurality of layers configuring the network, there is a problem that the inference time is not reduced.

In addition, the unstructured pruning compiler is not capable of being used together with a general inference high speed compiler such as TensorRT (Trademark) described above, and even in a case where the unstructured pruning compiler can be used together with the general inference high speed compiler, there is a problem that the inference time is not reduced.

As described above, there is a problem that the inference time is not capable of being reduced on the GPU in the DNN algorithm for which the weight is reduced by using unstructured pruning method.

### Solutions to Problems

One preferred aspect of the present invention is an information processing system, including: an unstructured pruning unit; a processing unit; a sharing unit; an inference high speed unit; and a control unit, in which the unstructured pruning unit performs unstructured pruning of a DNN model, the processing unit prunes and compresses, as selected layers, one portion of each layer of the DNN model, which has been trained, and does not prune and compress another portion, which serves as an unselected layer, the sharing unit shares the pruned and compressed selected layer, the control unit re-integrates the shared selected layers and the unselected layers to generate a re-integrated layer, and the inference high speed unit generates an execution file by optimizing the re-integrated layer to suit prescribed inference hardware.

Another preferred aspect of the present invention is a neural network conversion method for allowing a computer information processing system including an input device, an output device, a processing device, a memory, and a storage device to execute: unstructured pruning processing of performing unstructured pruning of a DNN model; compressing processing of pruning and compressing, as selected layers, one portion of each layer of the DNN model, which has been trained, and not pruning and compressing another portion, which serves as an unselected layer; sharing processing of sharing the pruned and compressed selected layers; integrating processing of re-integrating the shared selected layers and the unselected layers to generate a re-integrated layer; and inference high speed processing of generating an execution file by optimizing the re-integrated layer to suit prescribed inference hardware.

### Effects of the Invention

It is possible to reduce the inference time on the GPU in the DNN algorithm for which the weight is reduced by using the unstructured pruning method.

### BRIEF DESCRIPTION OF THE DRAWINGS

FIG. 1 is an explanatory diagram of unstructured pruning DNN processing of Example.

FIG. 2 is a configuration block diagram of an information processing system of Example.

FIG. 3 is a processing flowchart of the information processing system of Example.

FIG. 4 is an explanatory diagram illustrating another example of an unstructured pruning DNN processing flow of Example.

FIG. 5 is an explanatory diagram illustrating an inference time reduction effect of a selecting unit and a sharing unit of Example.

FIG. 6A is a graph illustrating the inference time reduction effect of Example.

FIG. 6B is an enlarged graph illustrating the inference time reduction effect of Example.

FIG. 7 is a graph illustrating the inference time reduction effect of Example.

FIG. 8 is a graph illustrating identification accuracy (AUC)-unstructured pruning rate dependency of Example.

FIG. 9 is a flowchart illustrating a detailed configuration of a pruning and compressing unit and a sharing unit of Example.

FIG. 10 is an unstructured pruning DNN processing flowchart of Comparative Example.

FIG. 11 is a flowchart illustrating a detailed configuration of a pruning and compressing unit of Comparative Example.

### MODE FOR CARRYING OUT THE INVENTION

Hereinafter, an embodiment of the present invention will be described with reference to the drawings. Examples are illustrative for describing the present invention, and are suitably omitted and simplified for the clarification of the description. The present invention can also be implemented in various other forms. Unless specifically limited, each component may be singular or plural.

The position, the size, the shape, the range, and the like of each constituent illustrated in the drawings may not represent the actual position, size, shape, range, and the like, in order to facilitate the understanding of the invention. Accordingly, the present invention is not necessarily limited to the position, the size, the shape, the range, and the like disclosed in the drawings.

As an example of various information pieces, various information pieces may be described by expressions such as a “table”, a “list”, and a “queue”, and may be expressed by other data structures. For example, various information pieces such as an “XX table”, an “XX list”, and an “XX queue” may be referred to as “XX information”. When described identification information, expressions such as “identification information”, an “identifier”, a “name”, an “ID”, and a “number” are used, and can be replaced with each other.

In a case where there are a plurality of constituents having the same or similar functions, the constituents will be described by applying different suffixes to the same reference numerals. In addition, in a case where it is not necessary to distinguish the plurality of constituents, the constituents may be described by omitting the suffixes.

In Examples, processing performed by executing a program may be described. Here, a computer executes a program by a processor (for example, a GPU or the like), and performs processing set by the program while using a storage resource (for example, a memory), an interface device (for example, a communication port), or the like. Accordingly, the subject of the processing performed by executing the program may be referred to as the processor. Similarly, the subject of the processing performed by executing the program may be a controller, a device, a system, a computer, or a node including the processor. The subject of the processing performed by executing the program may be a computation unit, and may include a dedicated circuit performing specific processing. Here, the dedicated circuit, for example, is a field programmable gate array (FPGA), an application specific integrated circuit (ASIC), a complex programmable logic device (CPLD), or the like.

The program may be installed in the computer from a program source. The program source, for example, may be a program distribution server or a computer-readable storage medium. In a case where the program source is the program distribution server, the program distribution server may include a processor and a storage resource storing a distribution target program, and the processor of the program distribution server may distribute the distribution target program to another computer. In addition, in Examples, two or more programs may be attained as one program, or one program may be attained as two or more programs.

A deep learning inference algorithm of Examples described below includes a selecting unit, an unstructured pruning compiler, a sharing unit, and an inference high speed compiler, and is attained by suitably combining the unstructured pruning compiler and the inference high speed compiler.

Among each layer of a DNN after unstructured pruning learning, only a layer (a selected layer) that is selected by the selecting unit is processed with the unstructured pruning compiler, and then, subjected to sharing processing by the sharing unit. The selected layer subjected to the sharing processing is re-integrated with a layer (an unselected layer) that is not selected by the selected layer, and then, processed with the inference high speed compiler to finally perform an inference operation on GPU hardware.

### Example 1

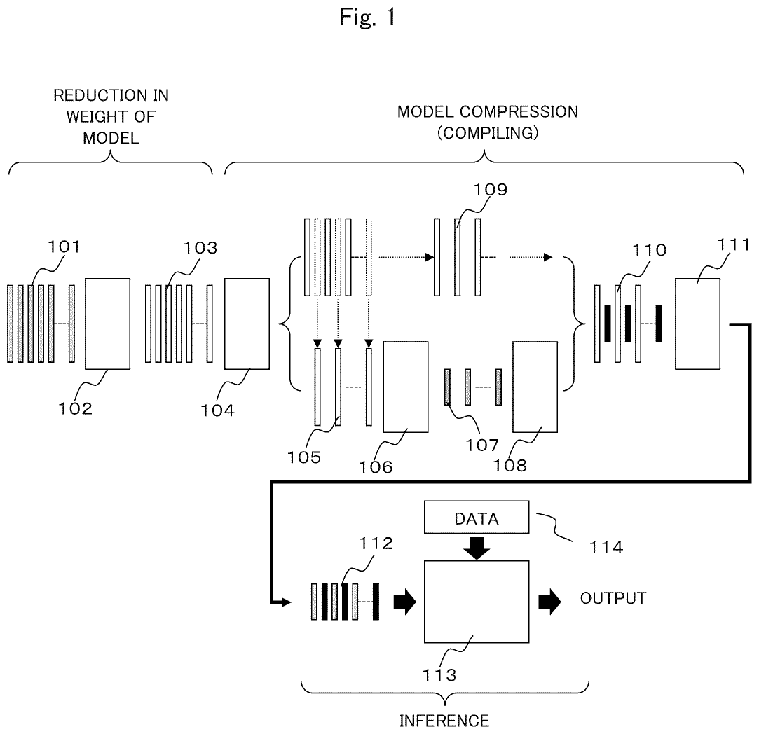

FIG. 1 illustrates the concept of an unstructured pruning DNN processing flow of this example. In a DNN model 101, a weight parameter is reduced by an unstructured pruning unit 102 to a desired pruning rate (=Number of Deleted Weight Parameters/Number of Original Weight Parameters×100, unit %).

It can be applied to any DNN model, and here, it is applied to a CNN for image identification such as VGG11, AlexNet, and ResNet18, and a DNN model for abnormality detection using the same. In addition, as the unstructured pruning unit 102, any unstructured pruning method can be applied, and here, a synaptic flow (Non-Patent Document 2), iterative SNIP, or an SNIP method, which is a pre-learning initialization pruning method that can be pruned before learning, and has a reduced learning time and a small decrease in an accuracy after learning is used.

The unstructured pruned DNN model is subjected to machine learning to generate a trained model 103. Each layer configuring the trained model 103 is classified into a selected layer 105 and an unselected layer 109 by a selecting unit 104. The selection condition of the selecting unit 104 includes a pruning rate in the DNN model, the size of a channel layer, the size of a filter layer, the number of multiprocessors in a GPU configuration, the size and the configuration of a memory, and the like. Here, the pruning rate is set to 50% or more, the size of the channel layer (a data matrix size) is set to 120 or less, and the size of the filter layer is set to 3×3, and the GPU configuration is any GPU configuration.

In the case of determining the selected layer, on the basis of the GPU configuration or performance, for example, it is considered to set a DNN model for which the weight is reduced by using an unstructured pruning method in weight unit such that a pruning rate is 95% or more, an image identification rate is 95% or more, and an inference time is 10 ms or less, using a GPU with the number of CUDA cores of 200 or less.

The selected layer 105 including a plurality of layers is compressed by a pruning and compressing unit (a compiler) 106 for each of the layers. As the pruning and compressing unit 106, here, SparseRT is used in which GitHub (Trademark) is published from Massachusetts Institute of Technology (MIT) and provided without cost (Non-Patent Document 3). For the same technology, for example, T. Gale et al., Sparse GPU Kernels for Deep Learning, arXiv:2006.10901v2 [cs.LG] 31 Aug. 2020 is referred to.

A pruning and compressing layer 107 processed by the pruning and compressing unit 106 for each of the layers is formed into one shared library by a sharing unit 108, and then, re-integrated with an unselected layer 109 to configure a re-integrated layer 110.

The re-integrated layer 110 is finally subjected to optimizing processing by an inference high speed unit (a compiler) 111, and then, executed by inference hardware 113 as an inference high speed layer (an execution file) 112.

The inference hardware 113 processes input image data 114, and executes inference processing such as object detection or abnormality detection according to a DNN model for an inference time according to the load of the execution file.

As the inference high speed unit 111, for example, a software development kit TensorRT (Trademark) for executing deep learning inference at a high speed, which is provided from NVIDIA Corporation as a GPU manufacturer can be used, and as the inference hardware 113, a GPU provided from NVIDIA Corporation can be used.

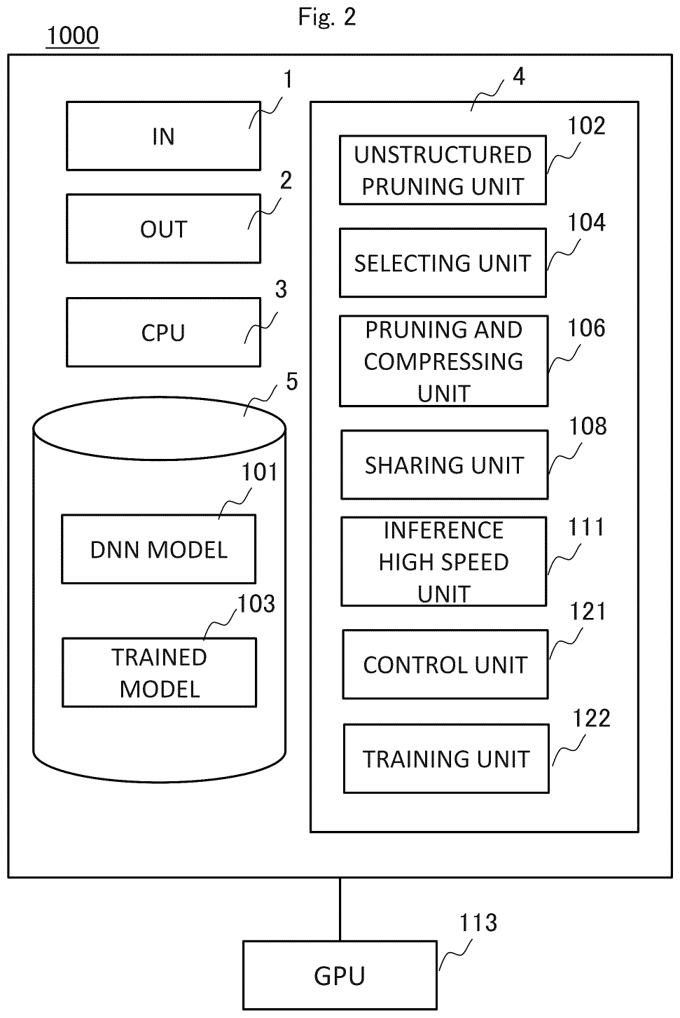

FIG. 2 illustrates a system block diagram of an information processing system of this example. An information processing system 1000, for example, can be configured by a computer (a server) including an input device 1, an output device 2, a processing device 3, a memory 4, and a storage device 5.

In this example, an example will be described in which the entire configuration is attained by one server, but any part may be configured by another computer. That is, the configuration is not limited insofar as data can be exchanged.

In this example, among each of the constituents illustrated in FIG. 1, the constituents other than the inference hardware 113 are implemented in the memory 4 as a program, and executed by the processing device 3, but may be configured by hardware having the same function. The storage device 5, for example, is configured by a magnetic disk device or the like. As the storage device 5, a database connected by a network may be used, and in this example, the storage device is a part of the information processing system 1000.

In addition, a control unit 121 of the information processing system 1000 controls the entire processing of Example. A training unit 122 has a function for training an inference model.

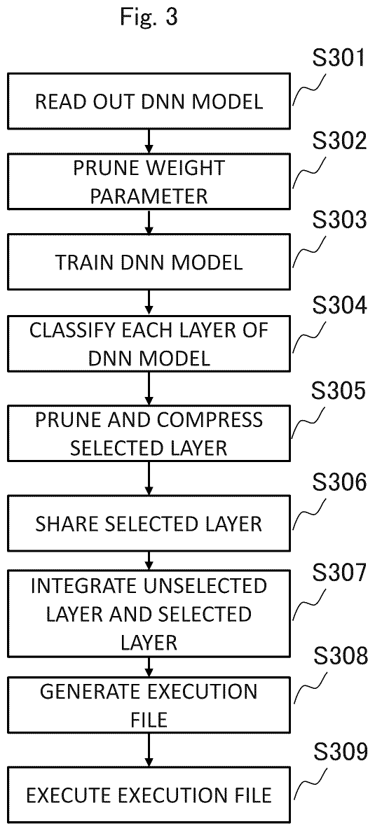

FIG. 3 illustrates a processing flow of the information processing system of this example.

First, the control unit 121 reads out the DNN model 101 from the memory 4, and sends the DNN model to the unstructured pruning unit 102 (S301).

The unstructured pruning unit 102 reduces the weight parameter of the DNN model 101 with a desired pruning rate (S302). In the unstructured pruning unit 102, Synaptic Flow is used.

The training unit 122 trains the DNN model for which the weight parameter is reduced by any known method to generate the trained model 103 and store the trained model in the memory 4 (S303).

The control unit 121 inputs the trained model 103 to the selecting unit 104, and classifies the trained model into the selected layer 105 and the unselected layer 109 by the selecting unit 104 (S304). Here, the classification is performed on the basis of the size of the layer.

The control unit 121 sends the selected layer 105 to the pruning and compressing unit 106, and the pruning and compressing unit 106 performs compression for each of the layers to generate the pruning and compressing layer 107 (S305). As the pruning and compressing unit 106, SparseRT is used.

The control unit 121 sends the pruning and compressing layer 107 to the sharing unit 108 to perform sharing (S306). The details of the sharing will be described below.

The control unit 121 re-integrates the pruning and compressing layer 107, which is formed into one shared library by the sharing unit 108, with the unselected layer 109 to configure the re-integrated layer 110 (S307).

The control unit 121 sends the re-integrated layer 110 to the inference high speed unit 111, and performs the optimizing processing to generate the inference high speed layer (the execution file) 112 (S308). In the optimizing processing, the re-integrated layer 110 performs processing of suiting inference hardware 113. For example, optimization is performed such that processing over the layers is collectively calculated in one layer. In addition, the size of the model and the amount of memory in use are reduced, and a high speed is attained by using computation elements in parallel. In addition, the usage of the memory is optimized. In addition, the optimization is performed by executing the inference in parallel with a plurality of streams.

The inference high speed layer (the execution file) 112 is executed by the inference hardware 113 (S309). As the inference high speed unit 111, TensorRT (Trademark) manufactured by NVIDIA Corporation is used, and as the inference hardware 113, GPU manufactured by NVIDIA Corporation is used.

### Example 2

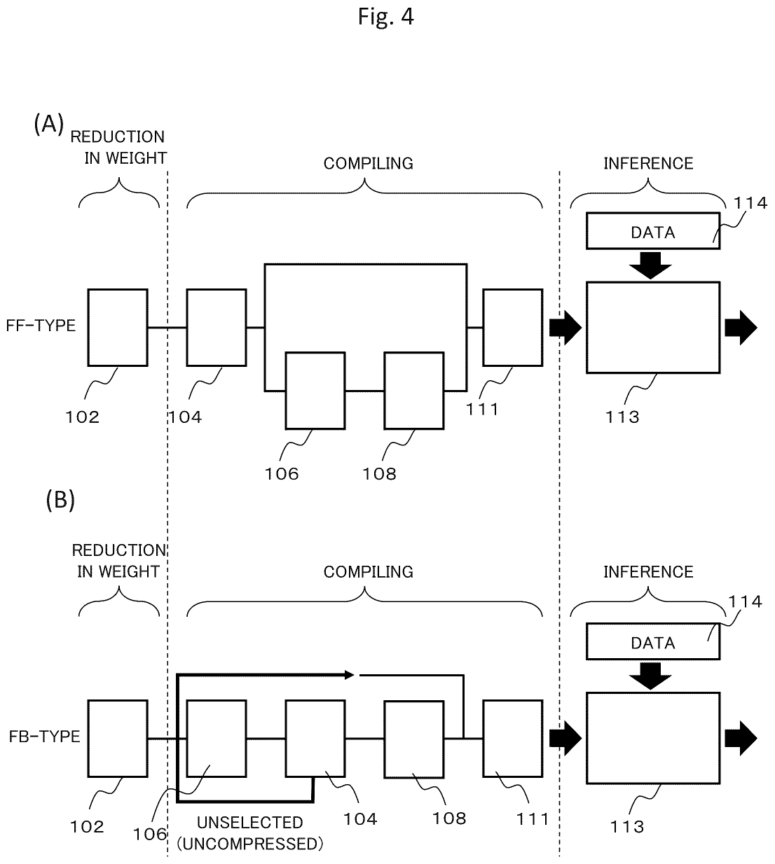

FIG. 4 illustrates a second configuration of the unstructured pruning DNN processing flow of Example. A first configuration (Example 1) in which the DNN layer is omitted from FIG. 1 is illustrated in FIG. 4(A), and compared with the second configuration (Example 2) illustrated in FIG. 4(B) to describe the difference.

In the first configuration, the selecting unit 104 sorts the selected layer 105 and the unselected layer 109 by using the selection condition set in advance, but for a DNN layer configuration or a GPU hardware configuration, which are constantly updated and complicated, the selection condition may not necessarily be the optimal condition for reducing the inference time.

In order to avoid this, in the second configuration, all the layers of the trained model 103 subjected to the pruning processing by the unstructured pruning unit 102 is subjected to the compressing processing by the pruning and compressing unit 106, and then, the inference time is evaluated by the selecting unit 104 for each of the layers of the pruning and compressing layer to sort the selected layer to which the pruning and compressing is applied and the unselected layer to which the pruning and compressing is not applied. For a layer sorted as the unselected layer, the compressing processing is undone, or the layer is replaced with a layer before compression.

The second configuration (feedback-type) takes more time than the first configuration (feedforward-type) due to repeated trial and error for sorting the selected layer and the unselected layer, but an inference time reduction effect according to the pruning and compressing of the selected layer is reliably expected. In addition, the compiling processing is completed before the inference processing using the inference hardware, and thus, does not affect the inference time.

### Example 3

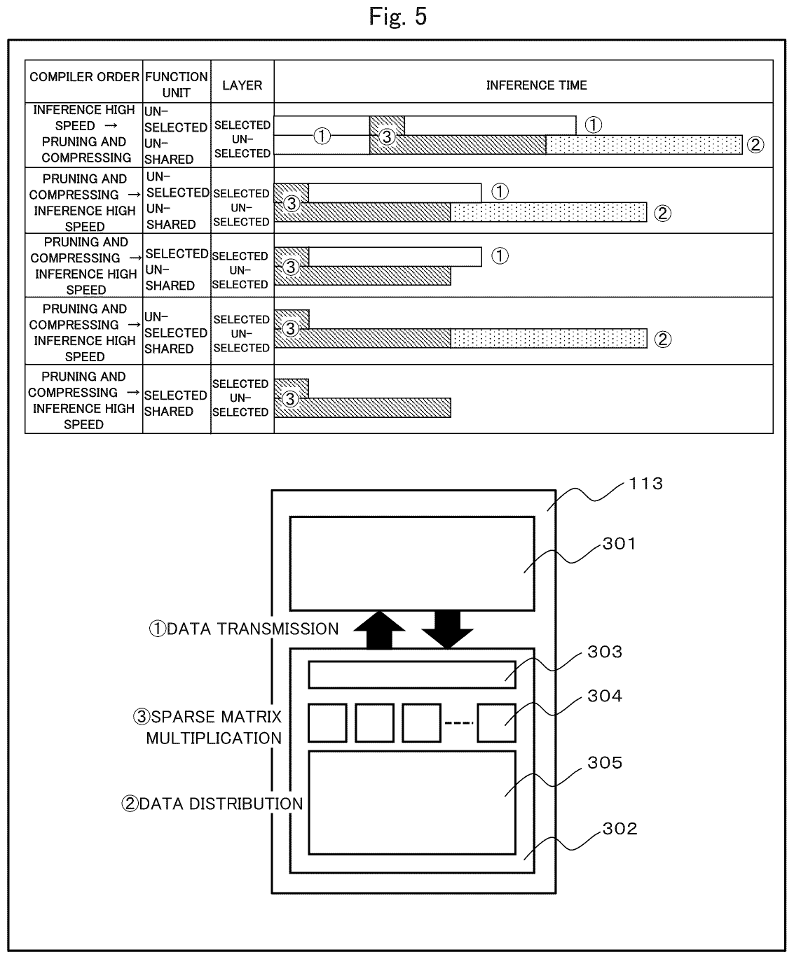

FIG. 5 illustrates the inference time reduction effect of Example 1. As illustrated in the lower portion of FIG. 5, the inference hardware 113 includes a CPU 301 and a GPU 302, and the GPU 302 includes an interface engine 303, a (stream) multiprocessor 304, and a memory 305. Data transmission is performed between the CPU 301 and the GPU 302 by a data bus.

The inference time mainly includes (1) a data transmission time between the CPU 301 and the GPU 302, (2) a data distribution time on the memory 305, and (3) a sparse matrix multiplication time on the multiprocessor 304.

A bar graph in the upper portion of FIG. 5 illustrates the inference time, in which the inference time depending on a difference such as the order of the compiler processing, and the presence or absence of a function unit such as the selecting unit and the sharing unit are illustrated in the bar graph.

The bar graph includes two stages of an upper stage and a lower stage, in which the upper bar graph is the inference time required for the processing of the selected layer, and the lower bar graph is the inference time required for the processing of the unselected layer. In addition, a white bar graph represents (1) the data transmission time between the CPU 301 and the GPU 302, a dotted bar graph represents (2) the data distribution time on the memory 305, and a shaded bar graph represents (3) the sparse matrix multiplication time on the multiprocessor 304.

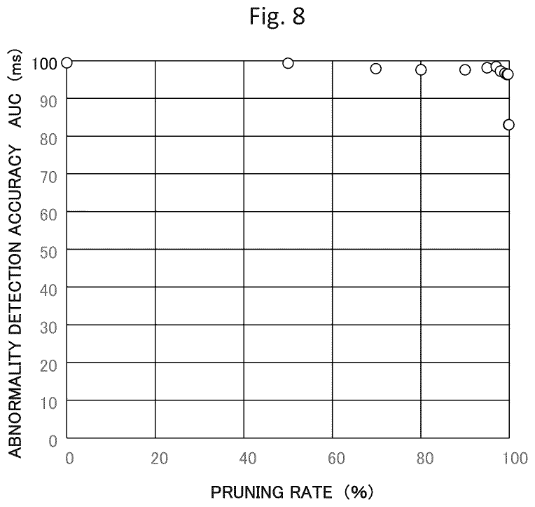

The first item from the top of the table in FIG. 5 shows the characteristic of an unstructured pruning DNN processing flow of Comparative Example described below by using FIG. 8. In such a configuration, the order of the compiler processing is an order from the inference high speed unit 116 to the pruning and compressing unit 106, in which the selecting unit 104 and the sharing unit 108 are not provided. In this case, for the following reason, (1) the data transmission time increases for both of the selected layer 105 and the unselected layer 109. Further, since there is no selecting unit 104, in the unselected layer 109, (2) an unnecessary data distribution time occurs on the memory 305. In addition, since there is no sharing unit 108, in the selected layer 105, (1) an unnecessary data transmission time occurs between CPU 301 and the GPU 302, and thus, the total inference time is not reduced.

The second item to the fourth item from the top of the table in FIG. 5 show a case where the order of the compiler processing is an order from the pruning and compressing unit 106 to the inference high speed unit 116. In such a case, (1) the data transmission time common to the selected layer 105 and the unselected layer 109 is reduced. However, in a case where at least one of the selecting unit 104 and the sharing unit 108 is not provided, in the unselected layer 109, (2) the unnecessary data distribution time occurs on the memory 305, in the selected layer 105, (1) the unnecessary data transmission time occurs between the CPU 301 and the GPU 302, or both of the unnecessary data distribution times occur, and thus, the inference time is not capable of being reduced.

The fifth item from the top of the table in FIG. 5 shows the characteristic of the DNN processing flow of Example 1. As with the unstructured pruning DNN processing flow of Example 1, the order of the compiler processing is an order from the pruning and compressing unit 106 to the inference high speed unit 116, and both of the selecting unit 104 and the sharing unit 108 are provided, and thus, (2) the unnecessary data distribution time on the memory 305 and (1) the unnecessary data transmission time between the CPU 301 and the GPU 302 are reduced. Accordingly, by pruning and compressing, and sharing the selected layer 105 using the pruning and compressing unit 106 and the sharing unit 108, it is possible to obtain the inference time reduction effect due to efficient sparse matrix multiplication.

### Example 4

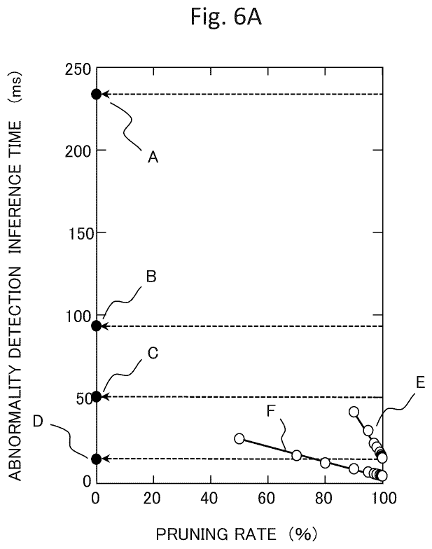

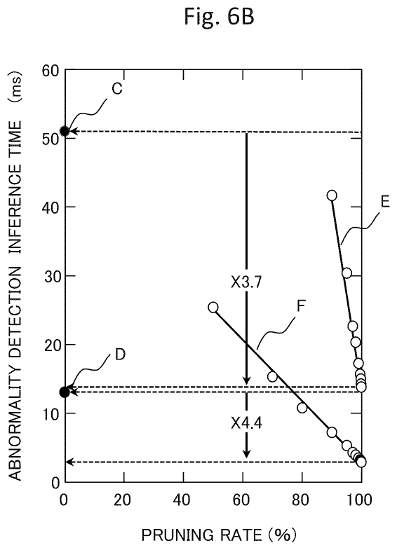

FIG. 6A and FIG. 6B illustrate the inference time reduction effect associated with an increase in the pruning rate in two types of GPUs as the inference hardware 113. As a built-in GPU model, Jetson Nano (Trademark) manufactured by NVIDIA Corporation (hereinafter, Nano: the number of CUDA cores of 128, power consumption of 2 to 10 W), and AGX Xavier (Trademark) (hereinafter, AGX: the number of CUDA cores of 512, power consumption of 40 W) are used.

As the inference high speed unit 111, TensorRT is used, as the pruning and compressing unit 106, SparseRT (Non-Patent Document 3) is used, and as the DNN model, an abnormality detection visualization DNN model is used.

The compiling processing of Example illustrated in FIG. 1 and FIG. 4 is applied to this DNN model, and the pruning rate dependency of the inference time is evaluated by using the two types of GPUs. As an image data set, MVTec AD published without cost for the abnormality detection of an industrial product is used, and as the unstructured pruning unit, Synaptic Flow (Non-Patent Document 2) is used.

In a case where both of the pruning and compressing unit 106 and the inference high speed unit 111 are not applied (none are applied), in a case where only the inference high speed unit 111 is applied (only the inference high speed unit is applied), and in a case where both of the pruning and compressing unit 106 and the inference high speed unit 111 are applied in the configuration of this example (Examples), the inference times are compared.

A characteristic A indicates a case where none are applied in Nano. A characteristic B indicates a case where none are applied in AGX. A characteristic C indicates a case where only the inference high speed unit is applied in Nano. A characteristic D indicates a case where only the inference high speed unit is applied in AGX. The characteristic of Examples to which Nano is adopted is indicated by E. The characteristic of Examples to which AGX is adopted is indicated by F.

There is no pruning rate dependency in inference time in a case where none are applied and in a case where only the inference high speed unit 111 is applied, and only in a case where both of the pruning and compressing unit 106 and the inference high speed unit 111 are applied in the configuration of this example, the inference time decreases in association with an increase in the pruning rate.

The pruning rate is set 50% to 99.9%, FIG. 6A enlargedly illustrates that the inference time on a vertical axis is 0 ms to 250 ms, and FIG. 6B enlargedly illustrates that the inference time is 0 ms to 60 ms.

In a case where the GPU model is Nano, the inference time, which is approximately 234 ms (the characteristic A) in a case where none are applied, decreases to 51 ms (the characteristic C) when only the inference high speed unit 111 is applied. In a case where both of the pruning and compressing unit 106 and the inference high speed unit 111 are applied in the configuration of this example, the inference time further decreases to 14 ms (the characteristic E).

In a case where the GPU model is AGX, the inference time, which is approximately 94 ms (the characteristic B) in a case where none are applied, decreases to 13 ms (the characteristic D) when only the inference high speed unit 111 is applied. In a case where both of the pruning and compressing unit 106 and the inference high speed unit 111 are applied in the configuration of this example, the inference time further decreases to 3 ms (the characteristic F).

Compared to a case where only the inference high speed unit 111 is applied, an inference rate in a case where this example is applied increases 3.7 times when the GPU model is Nano, and increases 4.4 times when the GPU model is AGX.

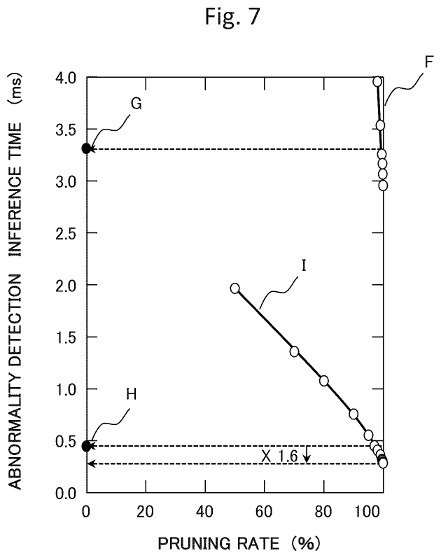

FIG. 7 illustrates the inference time reduction effect associated with an increase in the pruning rate of this example in the case of using a GPU model for a server. As the GPU model for a server, A100 Tensor core GPU manufactured by NVIDIA Corporation (hereinafter, A100: the number of CUDA cores of 6912, power consumption of 400 W) is used.

The inference time, which is approximately 3.3 ms (the characteristic G) in a case where none are applied, decreases to 0.45 ms (a characteristic H) when only the inference high speed unit 111 is applied. In a case where both of the pruning and compressing unit 106 and the inference high speed unit 111 are applied in the configuration of this example, the inference time further decreases to 0.29 ms (a characteristic I). Compared to a case where only the inference high speed unit 111 is applied, the inference rate in a case where this example is applied increases 1.5 times.

As described above, in comparison between three GPU models, it is found that the inference time reduction effect of this example is higher in the built-in GPU, in which the number of CUDA cores is comparatively small, and the parallel processing capability of the sparse matrix multiplication is low, than in the GPU for a server, in which the number of CUDA cores is large, and the parallel processing capability of the sparse matrix multiplication is high. That is, the reduction effect of a portion indicated by (3) in the graph of FIG. 5 is high.

This is because in the GPU for a server, an effect of performing the parallel processing of the sparse matrix multiplication by a plurality of multiprocessors (CUDA cores) is higher than an effect of compressing the sparse matrix multiplication after unstructured pruning by the pruning and compressing unit.

FIG. 8 illustrates identification accuracy (area under the curve: AUC)-unstructured pruning rate dependency of this example. The identification accuracy has the same value without having GPU model dependency, and even in a case where the pruning rate increases to 99.7%, a high identification accuracy of 95% or more is maintained. It is found that in this example, it is possible to reduce the inference time while maintaining a high identification accuracy in association with an increase in the unstructured pruning rate.

### Example 5

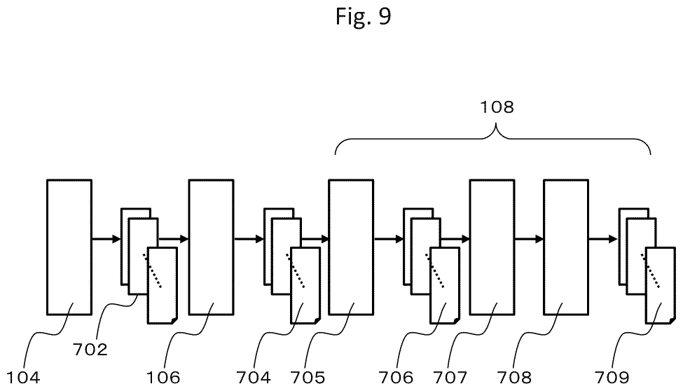

FIG. 9 illustrates the detailed configuration of the pruning and compressing unit 106 and the sharing unit 108 of this example. As a part of the configuration, hardware and software provided by NVIDIA Corporation can be applied. The detailed description of known or commercially available parts will be omitted.

The selecting unit 104 passes a NumPy-format file 702 of the weight coefficient of all the selected layers 105 to the pruning and compressing unit 106.

The pruning and compressing unit 106 outputs a compressed file relevant to the sparse matrix multiplication of the selected layer 105 in a PTX format (as a specific example, a pseudo-assembly language for a GPU manufactured by NVIDIA Corporation), as an all-selected layer compressed PTX file 704, on the basis of the NumPy-format file 702.

The all-selected layer compressed PTX file 704 is processed by the sharing unit 108. The sharing unit 108 has the functions of an assembler 705, a sparse matrix multiplication unit 707, and a compiling unit 708.

The assembler 705 generates a cubin file 706 of all the selected layers from the all-selected layer compressed PTX file 704. A specific example of the cubin file 706 of all the selected layers is a binary file for a GPU manufactured by NVIDIA Corporation.

The sparse matrix multiplication unit 707 executes the sparse matrix multiplication of all the compressed selected layers by using the cubin file 706 of all the selected layers. The sparse matrix multiplication is multiplication between the input image data and a sparse matrix after pruning.

The compiling unit 708 generates an execution file 709 of all the selected layers by using the sparse matrix multiplication result of all the compressed selected layers. Here, the execution file 709 is a binary file that can be executed by GPU hardware.

As described above, the pruning and compressing processing of all the selected layers is executed in advance without receiving an instruction from the inference hardware 113, and sharing between the CPU and the GPU is performed, and thus, it is possible to obtain an effect of reducing the inference time by reducing the unnecessary data transmission time between the CPU and the GPU in the inference hardware 113.

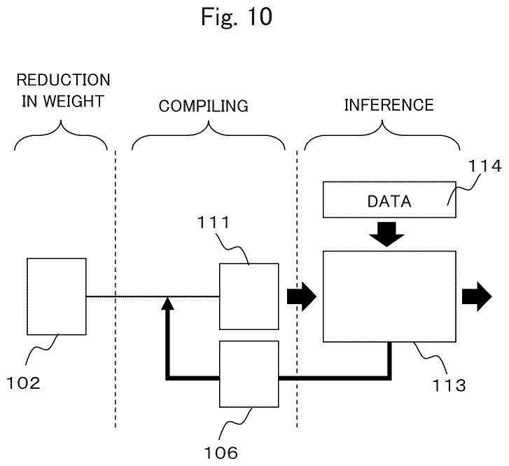

FIG. 10 illustrates the configuration of the unstructured pruning DNN processing flow of Comparative Example. In the configuration of Comparative Example, the selecting unit 104 and the sharing unit 108 in Examples described above are not provided, the DNN model pruned by the unstructured pruning unit 102 is subjected to the compiling processing by the inference high speed unit 111, and then, delivered to the inference hardware 113, and the pruning and compressing unit 106 is instructed to perform the compressing processing each time when the sparse matrix multiplication occurs during the inference execution.

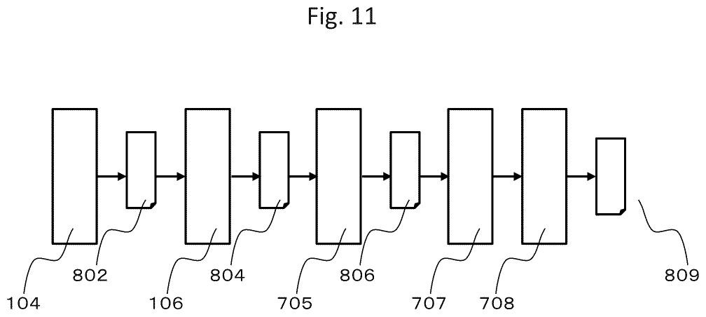

FIG. 11 illustrates the detailed configuration of a processing flow in the pruning and compressing unit of Comparative Example. A difference from the configuration of Example illustrated in FIG. 9 is that the files generated by each of the function units, that is, a single-layer weight NumPy file 802, a single-layer PTX file 804, a single-layer cubin file 806, and a single-layer execution file 809 are not for collectively all the layers but for each single layer.

Accordingly, since the pruning and compressing processing flow occurs each time when there is a pruning and compressing instruction from the inference hardware for each of the layers, the data transmission time is required, and thus, it is not possible to reduce the inference time. Therefore, the effect of reducing the inference time of this example is obvious, compared to Comparative Example.

According to Examples described above, the DNN algorithm for which the weight is reduced by the unstructured pruning method maintains a high identification accuracy to perform a high speed inference operation on the GPU hardware. It is possible to attain a system with low power consumption, which contributes to low energy consumption, a reduction in the amount of carbon dioxide emissions, the prevention of global warming, and the realization of a sustainable society.

### REFERENCE SIGNS LIST

101 DNN model
102 Unstructured pruning unit
103 Trained model
104 Selecting unit
105 Selected layer
106 Pruning and compressing unit (compiler)
107 Pruning and compressing layer
108 Sharing unit
109 Unselected layer
110 Re-integrated layer
111 Inference high speed unit (compiler)
112 Inference high speed layer
113 Inference hardware
301 CPU
302 GPU
303 Interface engine
304 (stream) Multiprocessor
305 Memory
702 NumPy-format file
704 All-selected layer compressed PTX file
705 Assembler
706 Cubin file
707 Sparse matrix multiplication unit
708 Compiling unit
709 Execution file of all selected layers
802 Single-layer weight NumPy file
804 Single-layer PTX file
806 Single-layer cubin file
809 Single-layer execution file

1. An information processing system, comprising:
an unstructured pruning unit;
a processing unit;
a sharing unit;
an inference high speed unit; and
a control unit,
wherein the unstructured pruning unit performs unstructured pruning of a DNN model,
the processing unit prunes and compresses, as selected layers, one portion of each layer of the DNN model, which has been trained, and does not prune and compress another portion, which serves as an unselected layer,
the sharing unit shares the pruned and compressed selected layers,
the control unit re-integrates the shared selected layers and the unselected layers to generate a re-integrated layer, and
the inference high speed unit generates an execution file by optimizing the re-integrated layer to suit prescribed inference hardware.

2. The information processing system according to claim 1,
wherein the processing unit includes a selecting unit and a pruning and compressing unit,
the selecting unit classifies each of the layers of the trained DNN model into a selected layer and an unselected layer, and
the pruning and compressing unit prunes and compresses the selected layer.

3. The information processing system according to claim 2,
wherein the selecting unit classifies the selected layer, on the basis of a size of each of the layers of the DNN model.

4. The information processing system according to claim 3,
wherein the selecting unit classifies a layer of which a size is a prescribed threshold value or less among each of the layers of the DNN model into the selected layer.

5. The information processing system according to claim 4,
wherein the selecting unit classifies a layer of which a data matrix size is 120 or less among each of the layers of the DNN model into the selected layer.

6. The information processing system according to claim 2,
wherein the selecting unit classifies the selected layer, on the basis of a pruning rate of the unstructured pruning unit of each of the layers of the DNN model.

7. The information processing system according to claim 6,
wherein the selecting unit classifies a layer in which the pruning rate of the unstructured pruning unit is a prescribed threshold value or more among each of the layers of the DNN model into the selected layer.

8. The information processing system according to claim 7,
wherein the selecting unit classifies a layer in which the pruning rate of the unstructured pruning unit is 50% or more among each of the layers of the DNN model into the selected layer.

9. The information processing system according to claim 1,
wherein the processing unit includes a selecting unit and a pruning and compressing unit,
the pruning and compressing unit prunes and compresses all the layers of the trained DNN model, and
the selecting unit returns some of the pruned and compressed layers of the DNN model to a state before compression.

10. The information processing system according to claim 9,
wherein the selecting unit evaluates an inference time for each of the pruned and compressed layers of the DNN model to sort layers to be returned to the state before compression.

11. The information processing system according to claim 1,
wherein the inference hardware includes a CPU and a GPU, and the GPU includes an interface engine, a stream multiprocessor, and a memory.

12. A neural network conversion method for allowing a computer information processing system including an input device, an output device, a processing device, a memory, and a storage device to execute:
unstructured pruning processing of performing unstructured pruning of a DNN model;
compressing processing of pruning and compressing, as selected layers, one portion of each layer of the DNN model, which has been trained, and not pruning and compressing another portion, which serves as an unselected layer;
sharing processing of sharing the pruned and compressed selected layers;
integrating processing of re-integrating the shared selected layers and the unselected layers to generate a re-integrated layer; and
inference high speed processing of generating an execution file by optimizing the re-integrated layer to suit prescribed inference hardware.

13. The neural network conversion method according to claim 12,
wherein in the compressing processing,
selecting processing of classifying each of the layers of the trained DNN model into a selected layer and an unselected layer, and
pruning and compressing processing of pruning and compressing the selected layer are executed.

14. The neural network conversion method according to claim 12,
wherein in the compressing processing,
pruning and compressing processing of pruning and compressing all the layers of the trained DNN model, and
selecting processing of returning some of the pruned and compressed layers of the DNN model to a state before compression is executed.

15. The neural network conversion method according to claim 12,
wherein the inference hardware includes a CPU and a GPU, and the GPU includes an interface engine, a stream multiprocessor, and a memory.
